(19) United States
(12) Patent Application Publication
(10) Pub. No.: US 2025/0183547 A1
(43) Pub. Date: Jun. 5, 2025

(54) ELECTROMAGNETIC-WAVE ABSORBER AND REFLECTOR, PLANAR ANTENNA, AND METHOD FOR MANUFACTURING ELECTROMAGNETIC-WAVE ABSORBER AND REFLECTOR

(71) Applicants: Yohei SHIREN, Tokyo (JP); Yukiko ABE, Kanagawa (JP); Shinichi HATANAKA, Tokyo (JP); Tomoo FUKUDA, Tokyo (JP); Takashi FUJITA, Kanagawa (JP); Hiroyuki HIRATSUKA, Kanagawa (JP); Asato TAMURA, Tokyo (JP); Tohru HASEGAWA, Kanagawa (JP); Hideo NAKAMORI, Shizuoka (JP); Yukihiro WAKABAYASHI, Kanagawa (JP); Kohji TAKEUCHI, Kanagawa (JP)

(72) Inventors: Yohei SHIREN, Tokyo (JP); Yukiko ABE, Kanagawa (JP); Shinichi HATANAKA, Tokyo (JP); Tomoo FUKUDA, Tokyo (JP); Takashi FUJITA, Kanagawa (JP); Hiroyuki HIRATSUKA, Kanagawa (JP); Asato TAMURA, Tokyo (JP); Tohru HASEGAWA, Kanagawa (JP); Hideo NAKAMORI, Shizuoka (JP); Yukihiro WAKABAYASHI, Kanagawa (JP); Kohji TAKEUCHI, Kanagawa (JP)

(21) Appl. No.: 18/844,055

(22) PCT Filed: Feb. 21, 2023
(86) PCT No.: PCT/IB2023/051552

§ 371 Date: Sep. 5, 2024

(30) Foreign Application Priority Data
Mar. 18, 2022 (JP) 2022-044204
Dec. 9, 2022 (JP) 2022-197447

(51) Int. Cl. H01Q 17/00; H01Q 15/14; H01Q 19/00; H01Q 19/10

(52) U.S. Cl. CPC H01Q 17/008; H01Q 15/141; H01Q 19/005; H01Q 19/10

(57) ABSTRACT

An electromagnetic-wave absorber and reflector includes a base material, and a plurality of unit patterns made of conductive material disposed at even intervals on a surface of the base material. In the electromagnetic-wave absorber and reflector, a portion of each of the plurality of unit patterns overlaps with a portion of adjacent one of the plurality of unit patterns in a stacking direction of the base material, and the portion of each of the plurality of unit patterns and the portion of adjacent one of the plurality of unit patterns have a dielectric layer interposed in between.

### TECHNICAL FIELD

Embodiments of the present disclosure relate to an electromagnetic-wave absorber and reflector, a planar antenna and a method for manufacturing the electromagnetic-wave absorber and reflector.

### BACKGROUND ART

Metamaterials are artificial structures that are used to manipulate, for example, the electromagnetic or thermal properties of materials, and mechanical vibration or oscillation of a substance. A metasurface or frequency selective plate is a type of two-dimensional metamaterial, and has an artificial surface used to manipulate the properties of, for example, the electromagnetic waves of a substance. For example, as illustrated in FIG. 1, a metasurface is dimensionally formed as conductive patterns P are two-dimensionally arrayed at even intervals.

By appropriately designing, for example, the size, pitch, or center-to-center distance of the patterns P, and the dielectric constant of a base material that bears the conductive patterns P, properties and characteristics such as absorption, reflection, and oscillation in response to the electromagnetic wave of a specific frequency can be controlled. The specific frequency, i.e., the resonance frequency f, is estimated by an equation as follows.

$$f = 1 / 2 π ( {L}_{eff} \times {C}_{eff} ) 1 / 2$$

In the above equation, L_{eff} and C_{eff} denote the inductance and the capacitance of an equivalent low complexity (LC) circuit provided for the patterns P.

The size of the patterns P that has periodic structure is adjusted to have a value equal to or smaller than ½ of the wavelength λ of the target electromagnetic wave. Typically, the size of the patterns P that has periodic structure is adjusted to have a value about 1/10 to ¼ of the wavelength. Currently, the development of electromagnetic-wave absorbers are desired that prevent the electromagnetic-wave autointoxication inside the communication devices in a band equal to or greater than 28 gigahertz (GHz) used in the fifth generation (5G) technology standard for broadband cellular networks. The size of the metamaterial or the metasurface that absorbs the band of 28 GHz tends to be about several millimeters, and such a size is too large to be introduced into a small-sized communication device. When a low-frequency electromagnetic wave equal to or lower than several GHz is handled, the size and pitch of the conductive patterns are equal to or larger than several centimeters. As described above, in a configuration where large-sized patterns are repeatedly arranged, it is difficult to introduce such large-sized patterns in narrow space as an electromagnetic-wave absorber. For the purposes of oscillation or vibration, the size of the antenna for low frequencies tends to increase.

A noise reduction sheet that is made of a soft magnetic material and makes use of a loss in magnetic properties is used as a low-frequency absorber below 1 GHZ. The amount of electromagnetic wave absorption of the noise reduction sheet of soft magnetic material depends on the thickness, and the thickness and weight of the sheet increase. At frequencies above 1 GHz, the amount of absorption of electromagnetic waves is reduced. Some technologies have been proposed to implement electromagnetic-wave absorbers for low frequencies, and a capacitor is soldered to the space between conductor patches that make up unit patterns of metamaterial in such electromagnetic-wave absorbers (see, for example, PTL 1 and NPL 1).

### CITATION LIST

### Patent Literature

[PTL 1]
Japanese Unexamined Patent Application Publication No. 2009-225159
[NPL 1]
Bui Xuan Khuyen, et al., “Ultra-subwavelength thickness for dual/triple-band methamaterial absorber at very low frequency”, Sci Rep. (2018) 8 (1): 11632

### SUMMARY OF INVENTION

### Technical Problem

The configuration in which the capacitor element is soldered between a pair of conductor patches is expensive and unsuitable for mass production. When a soldered capacitor element is used, the capacitor element has thickness in addition to the thickness of the metamaterial layer. For electromagnetic waves of 1 gigahertz (GHz), the thickness of the metamaterial layer on its own is submillimeter-sized. However, some capacitor elements are included, the metamaterial layer is one millimeter to several millimeters thick.

An aspect of the embodiments of the present disclosure is to provide a manufacturing an electromagnetic-wave absorber and reflector that is thin and can handle any desired frequencies without increasing the size of the conductor pattern formed on the surface of the base material.

### Solution to Problem

An electromagnetic-wave absorber and reflector according to one embodiment of the present disclosure includes a base material, and a plurality of unit patterns made of conductive material disposed at even intervals on a surface of the base material. In the electromagnetic-wave absorber and reflector, a portion of each one of the plurality of unit patterns overlaps with a portion of adjacent one of the plurality of unit patterns in a stacking direction of the base material, and the portion of each one of the plurality of unit patterns and the portion of adjacent one of the plurality of unit patterns have a dielectric layer interposed in between.

An electromagnetic-wave absorber and reflector according to another embodiment of the present disclosure includes a base material, a plurality of unit patterns of a first group disposed on a surface of the base material, the plurality of unit patterns being made of a first conductive material, a dielectric layer covering at least a portion of each one of the plurality of unit patterns of the first group, and a plurality of unit patterns of a second group disposed on the dielectric layer, the plurality of unit patterns of the second group being made of a second conductive material, each one of the plurality of unit patterns of the second group not overlapping with adjacent one of the plurality of unit patterns of the first group in a stacking direction the dielectric layer being interposed between the plurality of unit patterns of the second group and at least the portion of each one of the plurality of unit patterns of the first group.

### Advantageous Effects of Invention

A manufacturing an electromagnetic-wave absorber and reflector that is thin and a method of manufacturing the electromagnetic-wave absorber and reflector without increasing the size of the conductor pattern formed on the surface of the base material are implemented.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating a typical conductive pattern used for a metasurface, according to the related art.

FIG. 2 is a schematic diagram illustrating a basic configuration of an electromagnetic-wave absorber and reflector according to an embodiment of the present disclosure.

FIG. 3 is a schematic plan view of an electromagnetic-wave absorber and reflector according to a first embodiment of the present disclosure.

FIG. 4 is a A-A sectional view of the electromagnetic-wave absorber and reflector of FIG. 3 and illustrates its configuration or structure, according to the first embodiment of the present disclosure.

FIG. 5 is an additional A-A sectional view of the electromagnetic-wave absorber and reflector of FIG. 3 and illustrates its configuration or structure, according to the first embodiment of the present disclosure.

FIG. 6 is a further additional A-A sectional view of the electromagnetic-wave absorber and reflector of FIG. 3 and illustrates its configuration or structure, according to the first embodiment of the present disclosure.

FIG. 7A is a diagram illustrating the manufacturing processes of the electromagnetic-wave absorber and reflector of FIG. 4 according to the first embodiment of the present disclosure.

FIG. 7B is a diagram illustrating the manufacturing processes of the electromagnetic-wave absorber and reflector of FIG. 4 according to the first embodiment of the present disclosure.

FIG. 7C is a diagram illustrating the manufacturing processes of the electromagnetic-wave absorber and reflector of FIG. 4 according to the first embodiment of the present disclosure.

FIG. 8A is a diagram illustrating the manufacturing processes of the electromagnetic-wave absorber and reflector of FIG. 5 according to the first embodiment of the present disclosure.

FIG. 8B is a diagram illustrating the manufacturing processes of the electromagnetic-wave absorber and reflector of FIG. 5 according to the first embodiment of the present disclosure.

FIG. 8C is a diagram illustrating the manufacturing processes of the electromagnetic-wave absorber and reflector of FIG. 5 according to the first embodiment of the present disclosure.

FIG. 9A is a schematic sectional view of the electromagnetic-wave absorber and reflector of FIG. 4 and illustrates how its capacitance is increased, according to the first embodiment of the present disclosure.

FIG. 9B is a schematic sectional view of the electromagnetic-wave absorber and reflector of FIG. 5 and illustrates how its capacitance is increased, according to the first embodiment of the present disclosure.

FIG. 10 is a schematic diagram illustrating the adjustment of an electromagnetic-wave absorber and reflector using a capacitor, according to a second embodiment of the present disclosure.

FIG. 11 is a schematic diagram illustrating the adjustment of an electromagnetic-wave absorber and reflector using a capacitor, according to an alternative embodiment of the present disclosure.

FIG. 12 is a diagram illustrating a configuration or structure of an electromagnetic-wave absorber and reflector according to a third embodiment of the present disclosure.

FIG. 13 is another diagram illustrating an additional configuration or structure of an electromagnetic-wave absorber and reflector according to the third embodiment of the present disclosure.

FIG. 14 is a diagram illustrating the capacity coupling using a gap.

FIG. 15A and FIG. 15B are schematic diagrams each illustrating a characteristic-evaluation model using a cross pattern, according to an embodiment of the present disclosure.

FIG. 16 is a diagram illustrating the changes in absorption-frequency characteristics when the overlapping region in a direction horizontal to the plane of the unit patterns of the upper layer and the lower layer is changed, according to an embodiment of the present disclosure.

FIG. 17 is a diagram illustrating the changes in absorption-frequency characteristics when the gap in the stacking direction of the unit patterns of the upper layer and the lower layer is changed, according to an embodiment of the present disclosure.

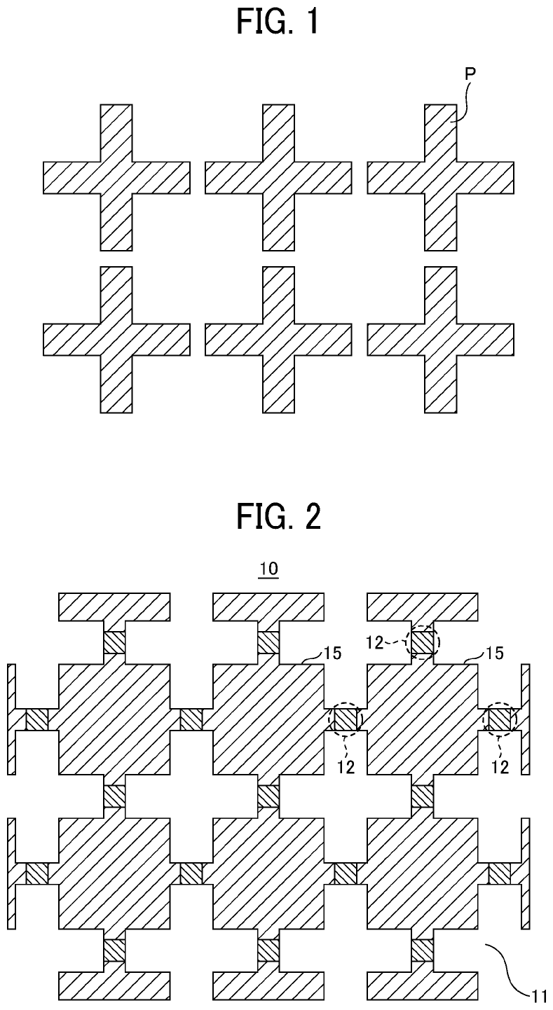

### DESCRIPTION OF EMBODIMENTS

In one embodiment of the present disclosure, a plurality of unit patterns that are made of conductive material and are repeatedly arranged overlap partially with a portion of an adjacent unit pattern in the stacking direction having a dielectric layer interposed therebetween. Due to such a configuration, capacity coupling is achieved between a pair of upper and lower patterns. The magnitude of the capacity coupling, i.e., the capacitance, can be adjusted to have a desired value by designing the area of overlapping regions, the thickness of the dielectric layer, and the dielectric constant.

In an alternative embodiment of the present disclosure, the unit patterns of the upper layer and the lower layer do not overlap each other in a direction horizontal to the plane and form capacity coupling in a direction horizontal to the substrate when viewed in a direction perpendicular to the substrate. Using portions of the multiple unit patterns, a capacitively-coupled portion of a desired magnitude is arranged between a pair of patterns. By so doing, properties and characteristics such as absorption, reflection, and oscillation of electromagnetic waves for lower frequencies can be achieved while keeping the size of the multiple unit patterns small.

The capacitively-coupled portion arranged between the adjacent unit patterns and the multiple unit patterns can be formed using a printing method such as an inkjet method, a screen printing method, and a spray method. A capacitively-coupled portion is coated with a thin film. By so doing, a thin electromagnetic-wave absorber and reflector can be made. The properties and characteristics in response to electromagnetic waves can be easily controlled only by changing the overlapping area of the capacitively-coupled portions, the thickness of the dielectric layer, and the material.

By forming a plurality of types of capacity couplings, a plurality of absorption or reflection spectra can be provided or the absorption or reflection spectra can be broadened.

An electromagnetic-wave absorber and reflector according to embodiments of the present disclosure are described below in detail. Among multiple embodiments of the present disclosure, like reference signs denote like elements, and redundant description may be omitted where appropriate.

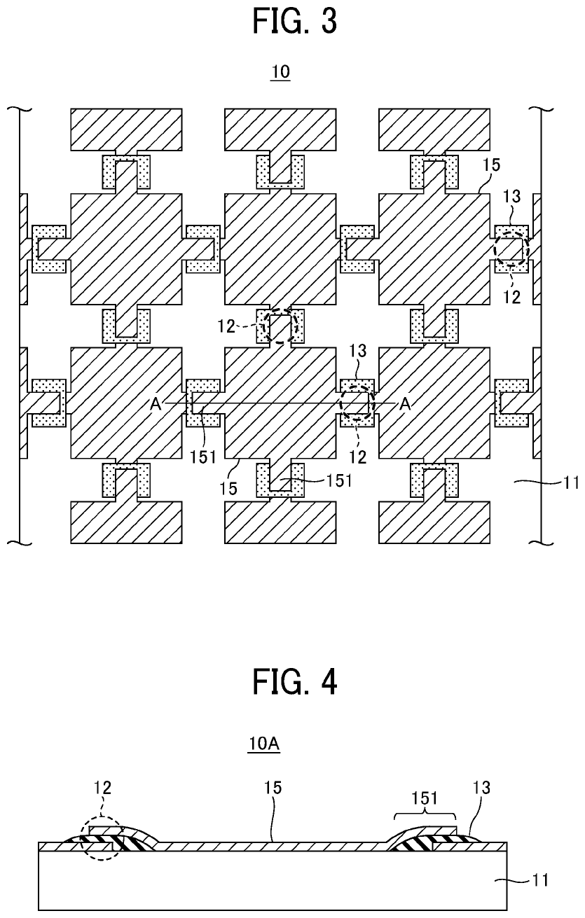

FIG. 2 is a schematic diagram illustrating a basic configuration of the electromagnetic-wave absorber and reflector 10 according to an embodiment of the present disclosure.

The electromagnetic-wave absorber and reflector 10 according to the present embodiment has a plurality of unit patterns 15 that are made of conductive material and are arranged at even intervals on the surface of the base material 11. For the sake of explanatory convenience, only a part of the repeated pattern of the multiple electromagnetic-wave absorber and reflectors 10 is illustrated. As illustrated in FIG. 2, a capacitively-coupled portion 12 is arranged between an adjacent pair of the multiple adjacent unit patterns 15. The capacitively-coupled portion 12 is formed by overlapping the adjacent pair of the multiple unit patterns 15. One of the multiple unit patterns 15 overlap with another adjacent one of the multiple unit patterns 15 in the stacking direction perpendicular to the base material 11 with a dielectric material interposed in between.

Unlike a configuration in which a capacitor element is soldered between conductor patches, the capacitively-coupled portion 12 is formed using the same coating film as the unit pattern 15. By selecting or changing the overlapping area between a pair of the multiple unit patterns 15 and the thickness and dielectric constant of the dielectric layer inserted therebetween, capacity coupling of a desired magnitude can be achieved. The base material 11 on which the unit pattern 15 is formed may be a dielectric material or a base material in which a dielectric film is formed on a metal foil. The base material 11 may be an inorganic dielectric material such as a thin glass plate or an electrically-insulative resin film. Alternatively, the base material 11 may be resin film formed by a printing method such as an ink jet method, a screen printing method, or a spray method. When a resin material is used as the base material 11, the electromagnetic-wave absorber and reflector 10 that has high flexibility can be obtained, and the electromagnetic-wave absorber and reflector 10 may be applied to, for example, a curved surface and a bent surface.

Typically, the sizes and center-to-center distances of the multiple unit patterns 15 in the vertical direction and the horizontal direction are determined according to the wavelength of the target frequency. By contrast, in the present embodiment, the capacitively-coupled portion 12 is coated with a thin film in the formation, and the magnitude of capacity coupling can be adjusted to have a desired value. Accordingly, the resonance frequency of the electromagnetic-wave absorber and reflector 10 is shifted to the low frequency side while maintaining the pattern size with respect to a higher frequency, thin and small electromagnetic-wave absorber and reflector 10 is realized.

When the electromagnetic-wave absorber and reflector 10 according to the present embodiment is used as an electromagnetic-wave absorbing sheet, the impedance in its entirety including the impedance of the capacitively-coupled portion 12 is adjusted such that the reflection coefficient Γ that indicates the ratio of the reflected wave to the incident wave (reflected wave/incident wave) gets close to zero. When the reflection coefficient Γ gets close to zero, the unique impedance of the electromagnetic-wave absorber and reflector 10 matches the impedance of air that is an electromagnetic wave propagation medium in appearance. In such cases, the incident electromagnetic wave is hardly reflected and is absorbed inside the electromagnetic-wave absorber and reflector 10.

When the electromagnetic-wave absorber and reflector 10 according to the present embodiment is used as a reflector, the impedance of the capacitively-coupled portion 12 may be adjusted such that the reflection coefficient Γ is maximized. In other words, when the electromagnetic-wave absorber and reflector 10 according to the present embodiment is used as a reflector, the impedance of the capacitively-coupled portion 12 may be adjusted such that the impedance of the electromagnetic-wave absorber and reflector 10 becomes infinite in appearance. Alternatively, the phase difference may be controlled such that the electromagnetic wave reflected by the adjacent multiple unit patterns 15 is directed in a desired direction. When the electromagnetic-wave absorber and reflector 10 is used as a planar array antenna, the magnitude of the capacitively-coupled portion is determined such that radio waves are emitted and received at maximum power at the target frequency.

When no capacitively-coupled portion 12 is arranged, the frequency selectivity is determined based on the sizes and pitches of the multiple unit patterns 15, and the multiple unit patterns 15 need to be increased in size for a low frequency equal to or less than several gigahertz (GHz).

In the present embodiment, the capacitively-coupled portion 12 is formed by a part of the multiple unit patterns 15 to implement a capacitively-coupled portion of a desired magnitude. Due to such a configuration, a lower frequency band can be handled while keeping the multiple unit patterns 15 small in size.

In the present embodiment described with reference to FIG. 2, a plurality of square-shaped conductor patterns are used as the multiple unit patterns 15. However, no limitation is indicated thereby, and the shape of each one of the multiple unit patterns 15 is not limited to a square shape. The triangular or hexagonal conductor patterns may be arranged in an arrangement having a repetitive periodicity, and a capacitively-coupled portion 12 may be arranged between adjacent unit patterns such that parts of the multiple unit patterns overlap each other in a direction perpendicular to the base material 11. Alternatively, circular, elliptical, or polygonal unit patterns may be arranged in grid patterns or in multiple rows in a staggered configuration to arrange the capacitively-coupled portion 12 between an adjacent pair of the multiple unit patterns 15.

The capacitively-coupled portion 12 does not need to be arranged between all the adjacent unit patterns 15, but may be arranged between at least two adjacent unit patterns 15. It is not necessary for the magnitudes of the capacity coupling arranged in the electromagnetic-wave absorber and reflector 10 to be equal to each other, and various kinds of capacity coupling may be arranged. Some embodiments of such a configuration or structure as described above are described below in detail.

### First Embodiment

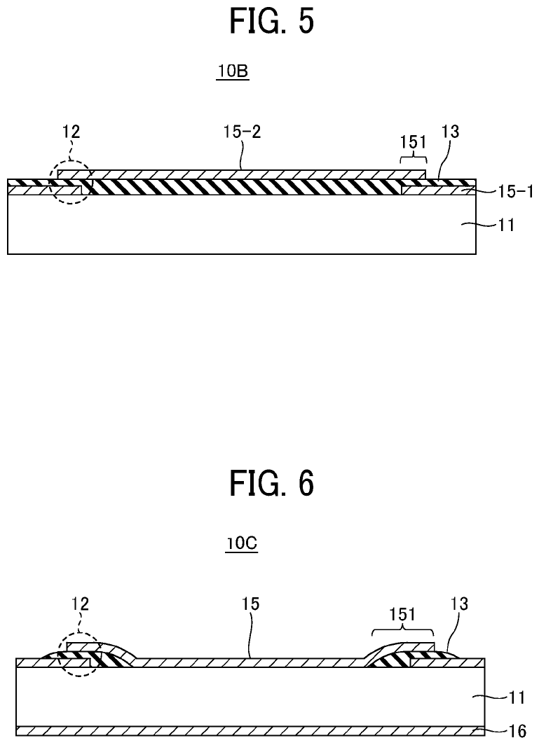

FIG. 3 is a schematic plan view of the electromagnetic-wave absorber and reflector 10 according to the first embodiment of the present disclosure.

The electromagnetic-wave absorber and reflector 10 according to the present embodiment adopts the basic configuration described above with reference to FIG. 2. The multiple unit patterns 15 that are made of conductive material and have substantially the same size and shape are arranged at even intervals on the surface of the base material 11. The expression “substantially the same” indicates that the size and shape are adjusted to be the same in design, and allows a manufacturing error within a permissible range.

At least some of the multiple unit patterns 15 has an arm 151 extending toward an adjacent one of the multiple unit patterns 15. The multiple arm 151 of one of the multiple unit patterns 15 overlaps with one of the multiple arm 151 of an adjacent one of the multiple unit patterns 15 in the stacking direction having the dielectric layer 13 interposed in between. The capacitively-coupled portion 12 is formed at the dielectric layer 13 interposed between the pair of upper and lower arms 151 that overlap with each other in the stacking direction.

The entirety of the multiple unit patterns 15 including the multiple arms 151 may be formed by a printing method such as ink jet printing or screen printing. Alternatively, the body of each one of the multiple unit patterns 15 excluding the arms 151 may be formed by, for example, air-temperature sputtering, and the capacitively-coupled portion 12 may be formed by a printing method. Among all the printing methods, the ink jet method is advantageous because the conductive material and the electrically-insulative material can be discharged to an accurate position on the base material 11 at a desired timing. Also when a flexible polymeric material is used for the base material 11, a printing method in which a pattern can easily be made at air-temperature is advantageous.

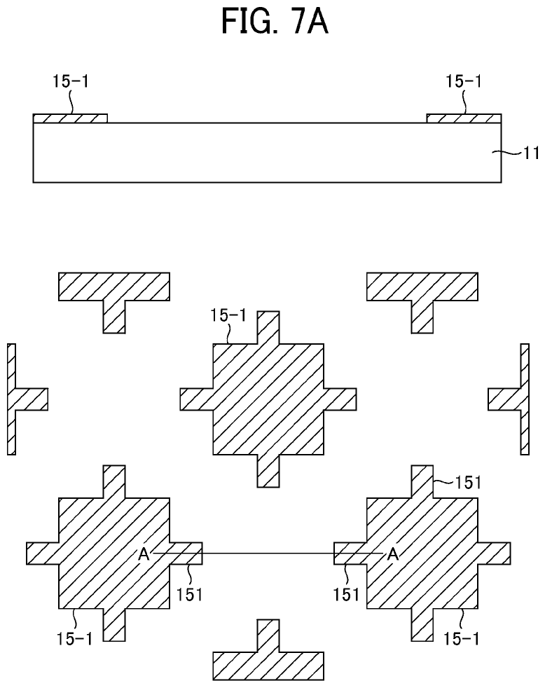

FIG. 4 is a A-A sectional view of the electromagnetic-wave absorber and reflector 10 of FIG. 3 and illustrates its configuration or structure, according to the first embodiment of the present disclosure.

In the electromagnetic-wave absorber and reflector 10A as illustrated in FIG. 4, The dielectric layer 13 is disposed only in a region where the multiple unit patterns 15 overlap each other. Each one of the multiple unit patterns 15 that is arranged on the base material 11 has the multiple arm s151 at a plurality of ends, and each one of the multiple arms 151 overlaps with one of the multiple arms 151 of an adjacent one multiple unit patterns 15. A dielectric layer 13 is inserted between the arm 151 on the lower side and the arm 151 on the upper side to form the capacitively-coupled portion 12. As a result, an adjacent pair of the multiple unit patterns 15 are electrically isolated from each other.

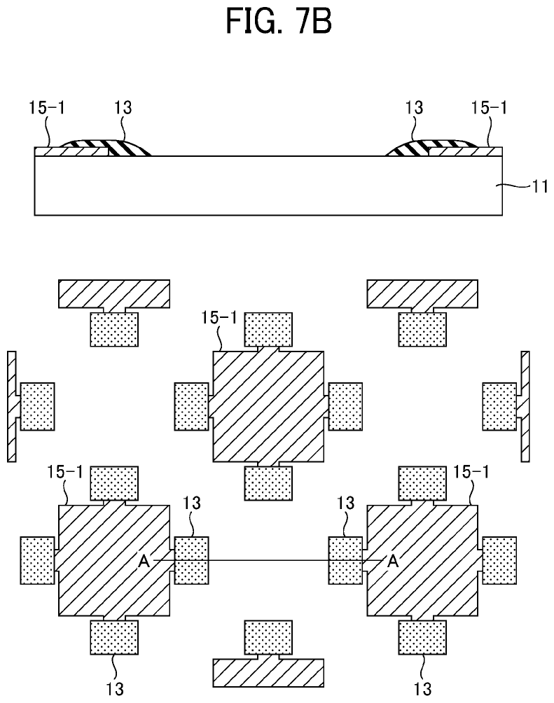

FIG. 5 is an additional A-A sectional view of the electromagnetic-wave absorber and reflector 10 of FIG. 3 and illustrates its configuration or structure, according to the first embodiment of the present disclosure.

In the electromagnetic-wave absorber and reflector 10B illustrated in FIG. 5, the dielectric layer 13 is formed on the entire surface of the base material 11. The unit pattern 15-1 that is arranged below the dielectric layer 13 and the unit pattern 15-2 that is arranged above the dielectric layer 13 overlap each other at the arm 151 having the dielectric layer 13 interposed therebetween. The capacitively-coupled portion 12 is formed between the arm 151 on the lower side and the arm 151 on the upper side that clamp the dielectric layer 13, and an adjacent pair of the multiple unit patterns 15 are electrically isolated from each other.

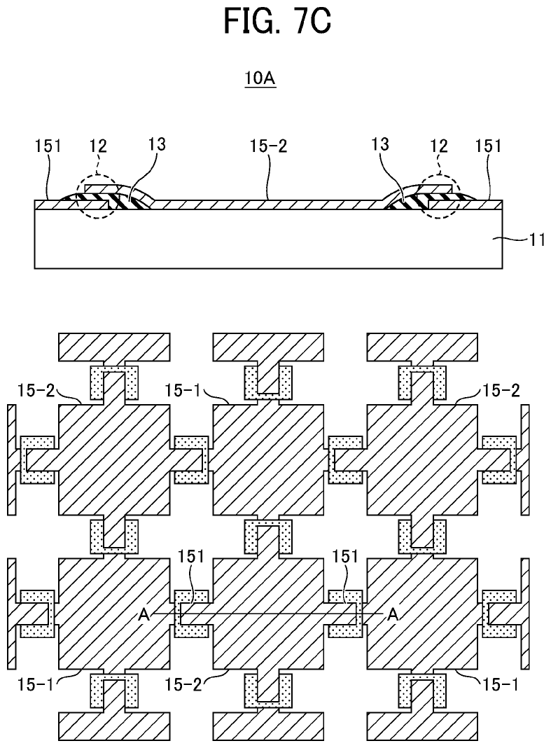

FIG. 6 is a further additional A-A sectional view of the electromagnetic-wave absorber and reflector 10 of FIG. 3 and illustrates its configuration or structure, according to the first embodiment of the present disclosure.

The electromagnetic-wave absorber and reflector 10C as illustrated in FIG. 6 has a ground layer 16 on the back surface of the base material 11 in addition to the configuration illustrated in FIG. 4. A capacitance is formed between each unit pattern 15 and the ground layer 16, and the magnitude of the phase delay can be controlled for each unit pattern 15. In the configuration or structure illustrated in FIG. 6, the ground layer 16 is added to the configuration or structure of FIG. 4. However, no limitation is indicated thereby, and as a matter of course, the ground layer 16 may be applied to the configuration or structure of FIG. 5.

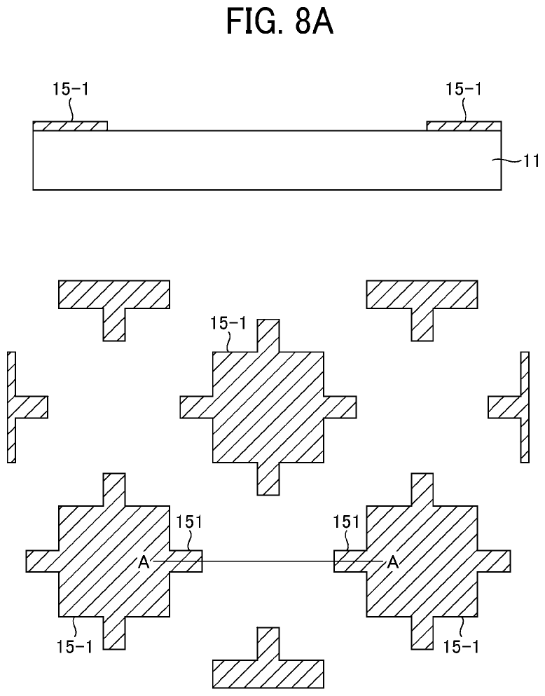

FIG. 7A, FIG. 7B, and FIG. 7C are diagrams illustrating the manufacturing processes of the electromagnetic-wave absorber and reflector 10A of FIG. 4 using top views and sectional views, according to the present embodiment.

In the process described with reference to FIG. 7A, the multiple unit pattern 15-1 of the first group are formed on the base material 11. In the case where the multiple unit patterns 15 have a lattice arrangement or grid pattern as illustrated in FIG. 3 in the final form, the multiple unit patterns 15-1 of the first group are alternately arranged and formed.

In the process described with reference to FIG. 7B, the multiple dielectric layers 13 are partially arranged so as to cover the multiple arms 151 of the multiple unit pattern 15-1 of the first group. The dielectric layer 13 may be formed on the arm 151 by ink jetting. The dielectric layer 13 does not need to be arranged on all the multiple arms 151 and may be formed only on selected one of the multiple arms 151.

In the process described with reference to FIG. 7C, the multiple unit patterns 15-2 of the second group are formed, and the electromagnetic-wave absorber and reflector 10A is obtained. The multiple arms 151 of the multiple unit patterns 15-2 of the second group are formed on the dielectric layer 13, and overlap with the multiple arms 151 of the multiple unit patterns 15-1 of the first group formed under the dielectric layer 13 in the stacking direction. The multiple unit patterns 15-2 of the second group may be formed by inkjet printing in its entirety. Alternatively, the areas of the multiple unit patterns 15-2 excluding the multiple arms 151 may be formed by screen printing, and the multiple arms 151 may be formed by inkjet printing.

The area of the capacitively-coupled portion 12 can be adjusted by adjusting the width of the arm 151 or the overlapping length thereof. The thickness of the dielectric layer 13 can be controlled by controlling the film formation processes. Accordingly, a capacitively-coupled portion of a desired magnitude can be formed between two adjacent unit patterns 15. The ground layer 16 (see FIG. 6) may be formed on the rear side of the base material 11 before the step described above with reference to FIG. 7A or after the step described above with reference to FIG. 7C.

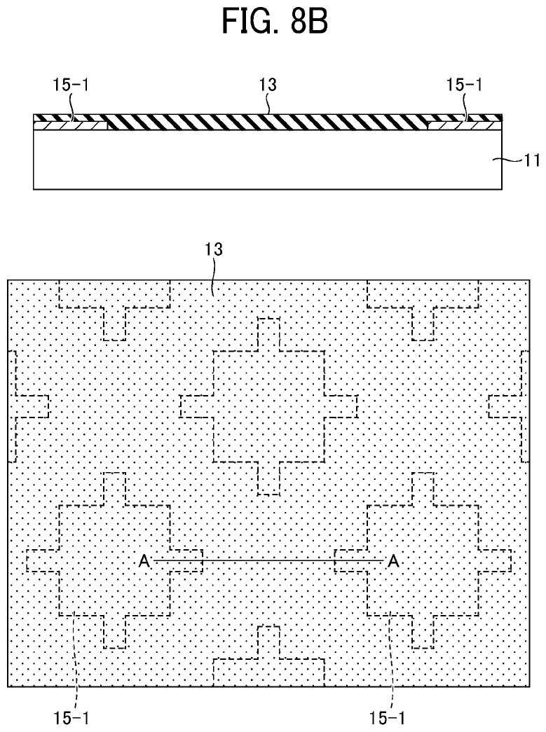

FIG. 8A, FIG. 8B, and FIG. 8C are diagrams illustrating the manufacturing processes of the electromagnetic-wave absorber and reflector 10B of FIG. 5 using top views and sectional views, according to the present embodiment.

In the process described with reference to FIG. 8A, the multiple unit pattern 15-1 of the first group are formed on the base material 11. In the case where the multiple unit patterns 15 have a lattice arrangement or grid pattern as illustrated in FIG. 3 in the final form, the multiple unit patterns 15-1 of the first group are alternately arranged and formed. The multiple unit patterns 15-1 are formed using an appropriate method such as a printing method or air-temperature sputtering.

In the process as illustrated in FIG. 8B, the dielectric layer 13 is formed to cover the entire surface of the base material 11 on which the unit pattern 15-1 is formed. The dielectric layer 13 may be formed as a coating film by a printing method, or may be formed by a method other than the printing method. In the process described with reference to FIG. 8C, the multiple unit patterns 15-2 of the second group are formed on the dielectric layer 13, and the electromagnetic-wave absorber and reflector 10B is obtained. The arm 151 of the unit pattern 15-2 of the second group overlaps the arm 151 of the unit pattern 15-1 of the lower layer in the stacking direction with the dielectric layer 13 interposed therebetween.

The multiple unit patterns 15-2 of the second group may be formed by printing method in its entirety. Alternatively, the areas of the multiple unit patterns 15-2 excluding the multiple arms 151 may be formed by screen printing, and the multiple arms 151 may be formed by inkjet printing or spraying method. By adjusting at least one of the width of the multiple arms 151 and the length of the overlapping to adjust the area of the capacitively-coupled portion 12 or by controlling the thickness of the dielectric layer 13, capacity coupling of a desired magnitude can be formed. The ground layer 16 (see FIG. 6) may be formed on the rear side of the base material 11 before the step described above with reference to FIG. 8A or after the step described above with reference to FIG. 8C.

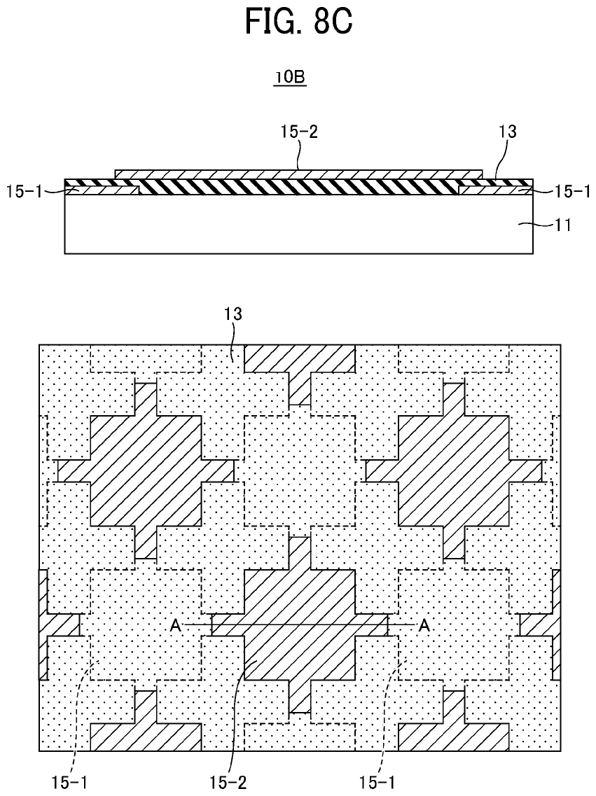

FIG. 9A is a schematic sectional view of the electromagnetic-wave absorber and reflector 10A of FIG. 4 and illustrates how its capacitance is increased, according to the first embodiment of the present disclosure.

FIG. 9B is a schematic sectional view of the electromagnetic-wave absorber and reflector 10B of FIG. 5 and illustrates how its capacitance is increased, according to the first embodiment of the present disclosure.

The degree of capacitance can be increased by further stacking the dielectric layer 13D or the dielectric layer 13E and the conductive layer 15-3 on the capacitively-coupled portion 12. In such cases, in a similar manner to the multilayer capacitor, the capacitance C can be expressed as in an equation given below.

$$C = ε ( S / d ) N [ F ]$$

In the above equation, S denotes the area in which the conductive layer overlaps with another conductive layer in the stacking direction, and d denotes the height of spacing between those conductive layers in the stacking direction. Moreover, in the above equation, ε denotes the dielectric constant, and N denotes the number of layers. The degree of capacitance can be increased by increasing the number of layers.

In the first embodiment of the present disclosure, the area of the capacitively-coupled portion 12 can be increased by adjusting at least one of the width of the multiple arms 151 of the multiple unit patterns 15 and the length of the overlapping. The dielectric layer 13 can be formed thin within a range in which the electrical insulation between an adjacent pair of the multiple unit patterns 15 can be achieved. The resonant frequency can be shifted to the low frequency side by increasing the area of the overlap between the arms 151 or reducing the thickness of the dielectric layer 13 to increase the degree of capacity coupling. The capacitively-coupled portion 12 is formed in the process of forming the multiple unit patterns 15. The height of the capacitively-coupled portion 12 formed in the thin-film forming process from the surface of the base material 11 is at least several μm and equal to or shorter than several tens of μm. As compared with a configuration in which a capacitor element is soldered, thin capacitively-coupled portion is formed by a simple process. The electromagnetic-wave absorber and reflector 10 or any one of the electromagnetic-wave absorber and reflectors 10A to 10E can be adjusted to desired frequencies while keeping the size of the multiple unit patterns 15 small.

### Second Embodiment

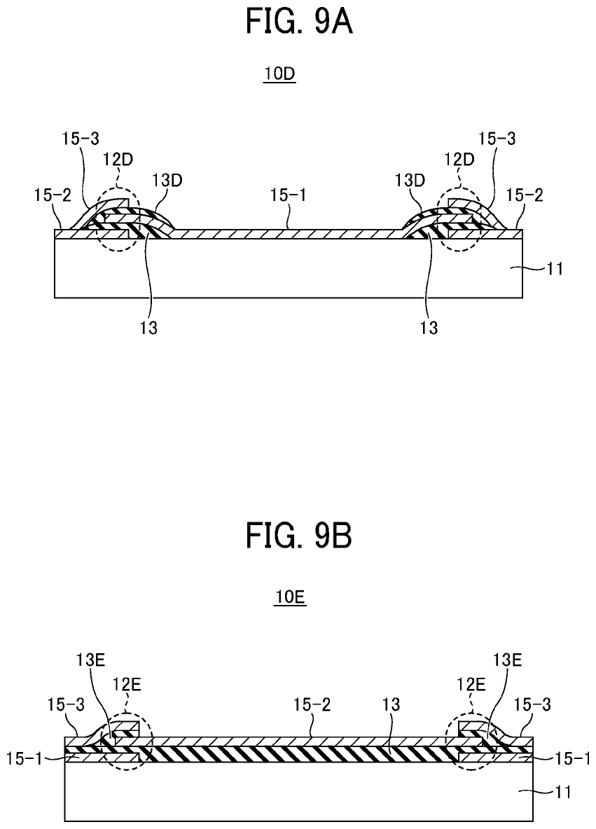

FIG. 10 is a schematic diagram illustrating the adjustment of the electromagnetic-wave absorber and reflector 20 using a capacitor, according to the second embodiment of the present disclosure.

In the first embodiment of the present disclosure, the area of the capacitively-coupled portion 12 is controlled by adjusting at least one of the width of the arms 151 of an adjacent pair of the multiple unit patterns 15 and the length of the overlapping. In FIG. 10, the size of the capacitively-coupled portion is adjusted by partially changing the shape of the arm.

In the electromagnetic-wave absorber and reflector 20 according to the present embodiment, the multiple unit patterns 25 are arranged at even intervals on the surface of the base material 21. At least some of the multiple unit patterns 25 has an arm 251 extending toward an adjacent one of the multiple unit patterns 25. The pair of arms 251 of an adjacent pair of the multiple unit patterns 25 overlap each other in the stacking direction perpendicular to the base material 11 with the dielectric layer 13 interposed in between. As a result, a capacitively-coupled portion 22 is formed at such an overlapping portion.

The arm 251 according to the present embodiment includes a base 252 coupled to an outer edge of the unit pattern 15, and a wide portion 253 at the front end of the base 252. The wide portion 253 overlaps with the wide portion 253 of the arm 251 of an adjacent one of the multiple unit patterns 25 in the stacking direction to form the capacitively-coupled portion 22. By increasing the area of the wide portion 253, the level of capacity coupling can be increased. Alternatively, the level of capacity coupling may be increased by reducing the film thickness of the dielectric layer 13.

In a similar manner to the first embodiment as described above, the unit pattern 25 and the dielectric layer 13 are formed easily and with high positioning accuracy by a printing method such as an inkjet method.

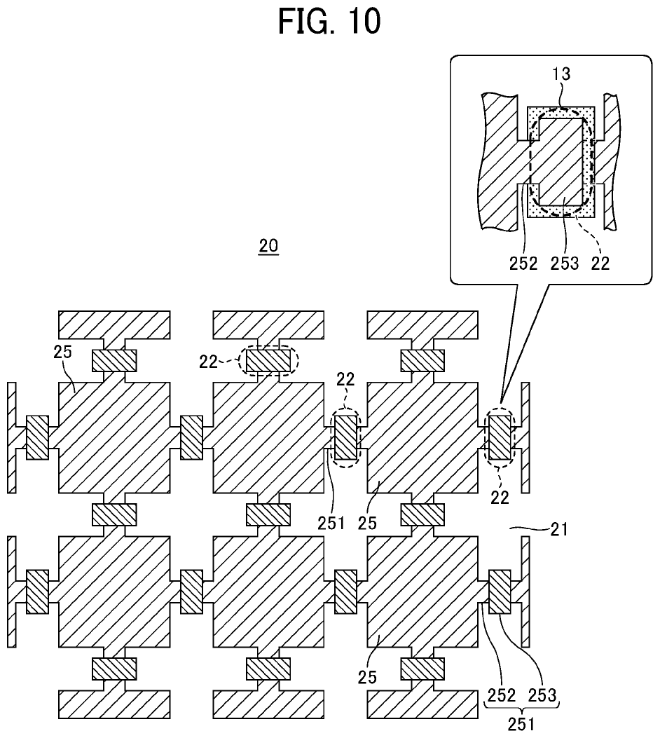

FIG. 11 is a schematic diagram illustrating the adjustment of an electromagnetic-wave absorber and reflector 30 using a capacitor, according to an alternative embodiment of the present disclosure.

In the first embodiment of the present disclosure, the overlapping between an adjacent pair of the multiple unit patterns 15 is adjusted by changing the length of the overlapping in the direction where the arms 151 extend. In FIG. 11, the overlapping of the arms 351 in the width (w) direction is adjusted to adjust the magnitude of capacity coupling.

In the electromagnetic-wave absorber and reflector 30 according to the present embodiment, the multiple unit patterns 35 are arranged at even intervals on the surface of the base material 31. At least some of the multiple unit patterns 35 has an arm 351 that extends toward an adjacent one of the multiple unit patterns 35. A part of the arm 351 overlaps with a part of the arm 351 of an adjacent one of the multiple unit patterns 35 in the stacking direction with the dielectric layer 13 interposed in between to form the capacitively-coupled portion 32.

By changing the overlapping amount in the width (w) direction of the arm 351, the area of the capacitively-coupled portion 32 changes. However, the length L or the size of the multiple unit patterns 35 in the vertical direction and the horizontal direction does not change. A change in the length L of the multiple unit patterns 35 affects the characteristic frequency. The magnitude of capacity coupling can be changed while keeping the length L of the multiple unit patterns 35 constant in the vertical direction and horizontal direction. Due to such a configuration, the impact of the change in size of the multiple unit patterns 35 on the characteristic frequency can be controlled, and the resonance frequency by the capacitively-coupled portion 32 can be controlled easily.

r

In a similar manner to the first embodiment as described above, the multiple unit patterns 25 and the dielectric layer 13 can be easily formed with high positioning accuracy by using a printing method such as an inkjet method. The amount of overlapping of the arm 351-1 at the lower level and the arm 351-2 at the upper level in the width direction can be controlled by adjusting the alignment accuracy of the ink jet. The amount of overlapping in the width direction between the adjacent arms is not necessarily constant, and only some of the arms may overlap in the width direction with the dielectric layer 13 interposed in between. Due to such a configuration, while preventing an increase the number of multiple unit patterns 35, the electromagnetic-wave absorber and reflector 30 that is thin can deal with a low frequency band equal to or lower than several GHz can be implemented.

### Third Embodiment

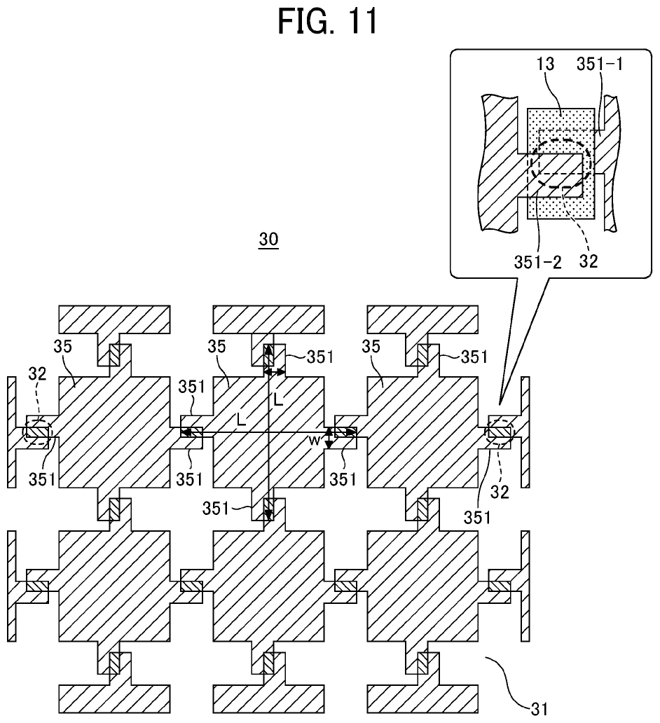

FIG. 12 is a diagram illustrating a configuration or structure of an electromagnetic-wave absorber and reflector 40 according to the third embodiment of the present disclosure. In the third embodiment of the present disclosure, capacity coupling having different magnitudes are arranged. As the electromagnetic-wave absorber and reflector 40 has a plurality of types of capacity coupling, the bandwidth of the electromagnetic wave to be absorbed or reflected can be widened.

In the electromagnetic-wave absorber and reflector 40 according to the present embodiment, the multiple unit patterns 45 are arranged at even intervals on the surface of the base material 41. At least some of or all of the multiple unit patterns 45 has an at least one of an arm 451 and an arm 452 that extend toward an adjacent one of the multiple unit patterns 45. The width w of arm 451 may be made different from the width w of the arm 452. The width w of the arm 451 or the arm 452 may be changed in order to change the area of the capacitively-coupled portion. Alternatively, the length of overlapping in the direction orthogonal to the width w of those arms may be changed in order to change the area of the capacitively-coupled portion.

For example, the capacitively-coupled portions 42a, 42b, and 42c having different capacitances may be arranged in ascending order of the overlapping area. The number of types of capacitively-coupled portions is not limited to three, and may be two, four, or more. By gradually changing the magnitude of the capacity coupling, the bandwidth of the target frequency can be widened.

Also in the configuration or structure described with reference to FIG. 12, the resonance frequency can be shifted to the low frequency while keeping the size of the multiple unit patterns 45 small. As a result, the electromagnetic-wave absorber and reflector 40 according to the third embodiment of the present disclosure can handle frequency band equal to or lower than several GHz.

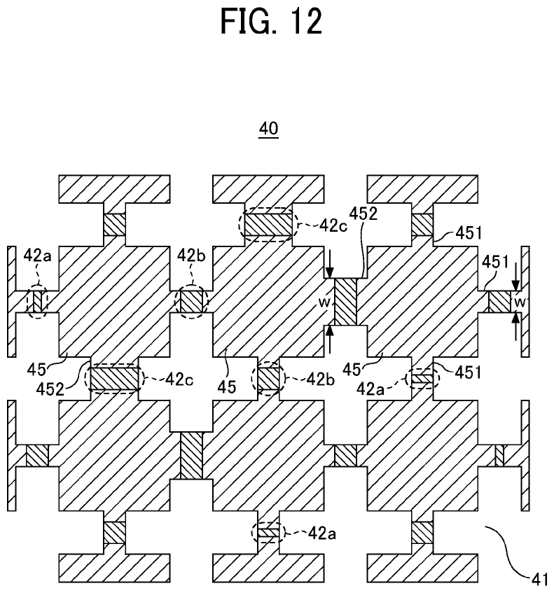

FIG. 13 is another diagram illustrating an additional configuration or structure of an electromagnetic-wave absorber and reflector 50 according to the third embodiment of the present disclosure.

In FIG. 13, at some portions of various kinds of capacity coupling, capacity coupling that has airspace interposed in the horizontal direction is adopted for the multiple unit patterns 55. It is not always necessary for the unit patterns 55 that form capacity coupling in the horizontal direction to overlap with each other in the stacking direction. In the electromagnetic-wave absorber and reflector 50 according to the present embodiment, the multiple unit patterns 55 are arranged at even intervals on the surface of the base material 51. At least some of or all of the multiple unit patterns 55 has an arm 551 that extends toward an adjacent one of the multiple unit patterns 55. A first capacitively-coupled portion 52a is formed at a position where the pair of arms 551 of an adjacent pair of the multiple unit patterns 55 overlap each other in the stacking direction with the dielectric layer 13 interposed in between. At portions where the two arms 551 of an adjacent pair of the multiple unit patterns 55 do not overlap with each other in the stacking direction, a second capacitively-coupled portion 52b is formed by the pair of arms 551 that surround a gap 552 in between. In other words, at separated portions in a direction horizontal to the plane, the second capacitively-coupled portion 52b is formed by the pair of arms 551 that surround the gap 552 in between. The width of the gap 552 may be changed in order to further increase the number of types of capacity coupling.

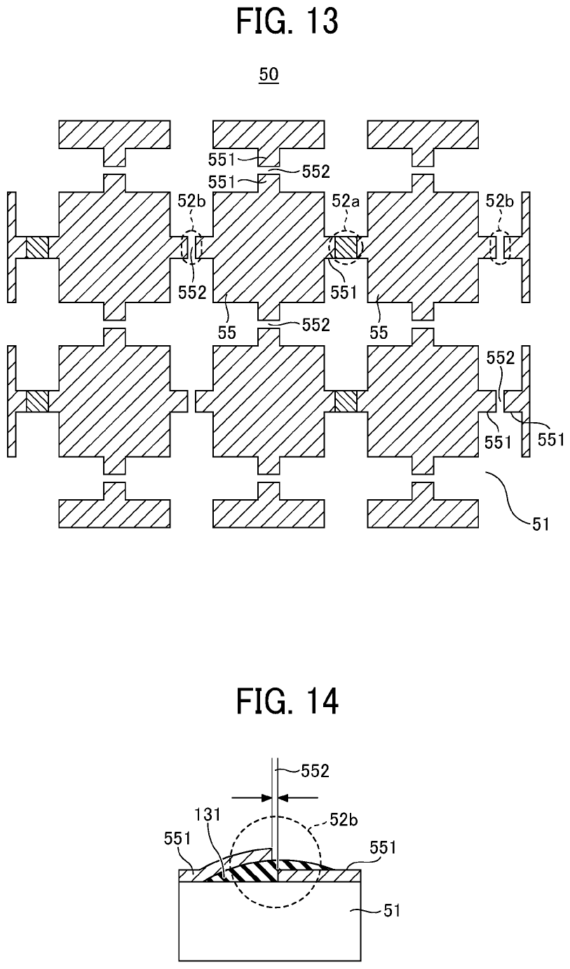

FIG. 14 is a diagram illustrating the capacity coupling using the gap 552, according to the present embodiment.

Also in the configuration of FIG. 13, the resonance frequency can be shifted to the low frequency side while the size of the multiple unit patterns 55 is kept small, such that a frequency band of several GHz or less can be dealt with. As a result, the electromagnetic-wave absorber and reflector 40 according to the third embodiment of the present disclosure can handle frequency band equal to or lower than several GHz. As illustrated in FIG. 14, an insulating layer 131 may be applied to the gap 552 to form the second capacitively-coupled portion 52b. Due to such a configuration, dielectric breakdown can be prevented, and the electrical insulation between an adjacent pair of the multiple arms 551 can be achieved. As a result, the capacitively-coupled portions can be implemented that are arranged at intervals narrower than the intervals of the highest accuracy of the selected manufacturing method, and the degree of selectivity of wavelength in design can be increased.

### Evaluation of Absorptivity (Calculated Value)

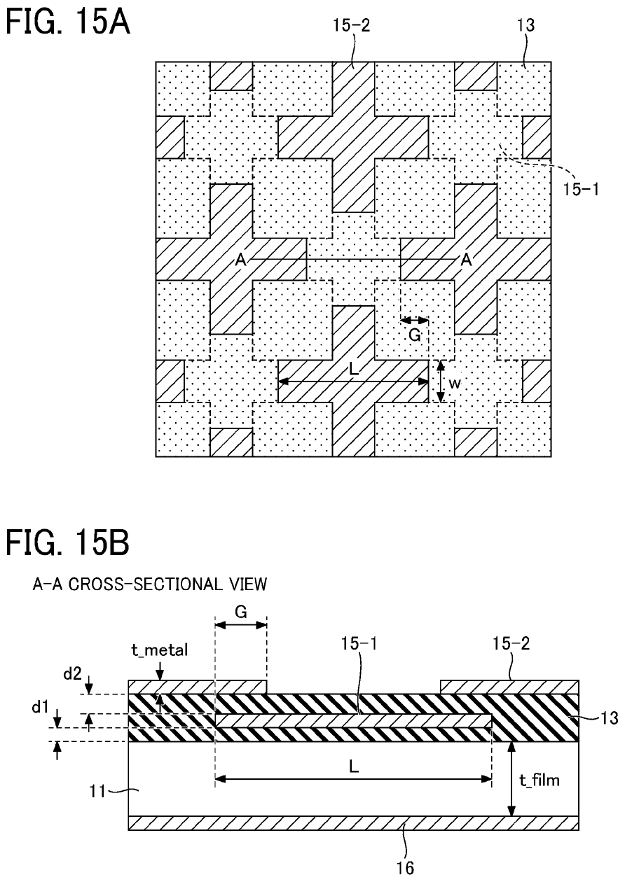

FIG. 15A and FIG. 15B are schematic diagrams each illustrating a characteristic-evaluation model using a cross pattern, according to the present embodiment.

In FIG. 15A and FIG. 15B, L denotes the size of each cross, and w denotes the line width of each cross. Moreover, in FIG. 15A and FIG. 15B, G denotes the overlapping length between the unit pattern 15-1 at the lower level and the unit pattern 15-2 at the upper level, and t_film denotes the thicknesses of the base material 11. Moreover, in FIG. 15A and FIG. 15B, t_metal denotes the thicknesses of the conductive layer that makes up a unit pattern, and d1 denotes the thicknesses of the dielectric layer 13 arranged between the base material 11 and the unit pattern 15-1 in the lower level. Moreover, in FIG. 15A and FIG. 15B, d2 denotes the thickness of the dielectric layer 13 between the unit pattern 15-1 at the lower level and the unit pattern 15-2 at the upper level.

When the unit pattern 15-1 at the lower level and the unit pattern 15-2 at the upper level overlap each other when viewed in the direction perpendicular to the plane, the overlapping length G is arranged so as to take a positive value. In other words, the overlapping region in a direction horizontal to the plane of the unit patterns of the upper layer and the lower layer is arranged so as to take a positive value. When the gap 552 is present in a direction horizontal to the plane as illustrated in FIG. 14, the overlap length G takes a negative value.

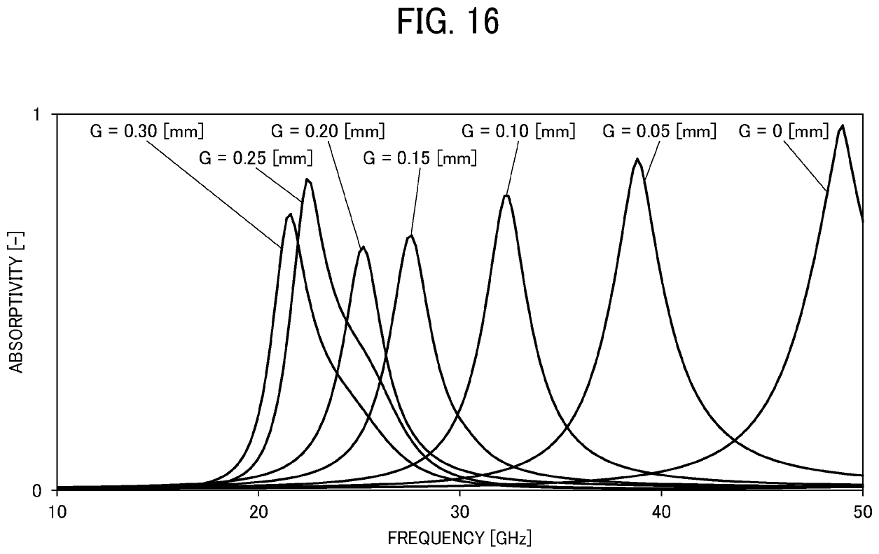

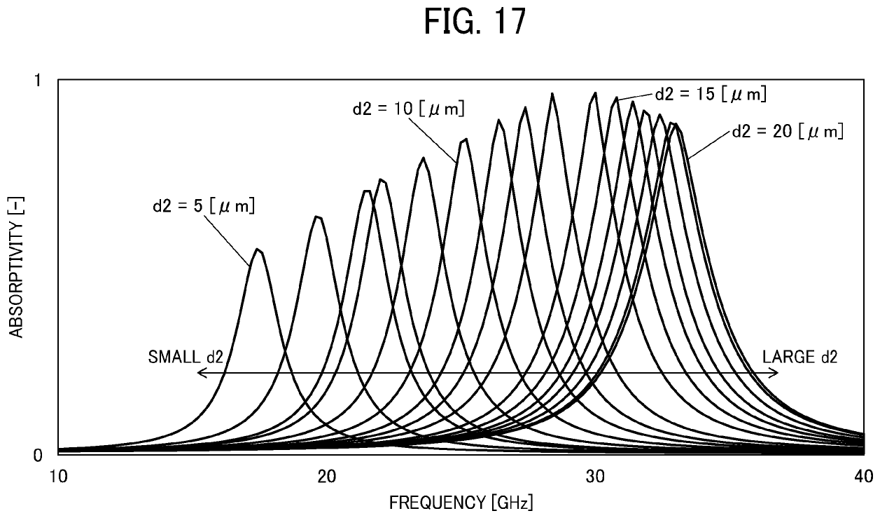

In view of the above configuration or mechanism, FIG. 16 and FIG. 17 illustrate the results of the calculation performed under the conditions that the relative dielectric constant ε of the base material 11 is 3.4, the dielectric loss tangent tan δ is 0.004, the relative dielectric constant ε of the dielectric layer 13 is 3.02, the dielectric loss tangent tan δ is 0.028, and the conductivity of the conductive layer is 2×10\hat{ }7 siemens/m.

In the calculation, the amount of absorption is obtained based on the intensity of reflection of the electromagnetic wave incident on the surface of the patterns.

FIG. 16 is a graph illustrating the relation between the frequencies and the amounts of absorption when the overlapping length G is changed from 0 millimeters (mm) to 0.30 mm, according to the present embodiment. Note also that L=1.0 mm, w=0.3 mm, t_metal=0.2 μm, t_film=100 μm, d=1.6 μm, and d2=10 μm in FIG. 6.

As the overlapping length G between the unit pattern 15-1 at the lower level and the unit pattern 15-2 at the upper level is greater, the absorption frequency decreases. Due to such a configuration, absorbers having desired absorption frequency can be obtained by adjusting the overlapping length G in design.

If the upper and lower portions of the metallic pattern in a direction perpendicular to the plane are not taken into consideration, the size of unit cells in repeated patterns in a direction horizontal to the plane becomes equal to or greater than 0.7 mm obtained by an equation “L-G” and becomes equal to or smaller than 1.0 mm, and becomes 1/20 at the minimum for the wavelength at the peak of absorption. The thickness becomes about 112 μm, and becomes 1/120 at the minimum for the wavelength at the peak of frequency. Accordingly, reduction in thickness can be achieved.

FIG. 17 is a graph illustrating the relation between the frequencies and the amounts of absorption when the thickness d2 is changed from 5 μm to 20 μm, according to the present embodiment. Note also that L=1.0 mm, w=0.7 mm, t_metal=0.2 μm, t_film=100 μm, d=1.6 μm, and G=0.1 mm in FIG. 7.

As the thickness d2 of the dielectric layer 13 between the unit pattern 15-1 at the lower level and the unit pattern 15-2 at the upper level is smaller, the absorption frequency decreases. Due to such a configuration, absorbers having desired absorption frequency can be obtained by adjusting the thickness d2 in design. In the present embodiment, the thickness d2 of the dielectric layer 13 that separates the unit patterns of the upper layer and the lower layer from each other is adjusted to have variations. By so doing, the peak of absorption of the absorber can be broadened. The expression variation or variations used in the present embodiment may indicate, for example, variations that accidentally occur in manufacturing processes and variations that are designed to occur. For example, variations in landing position and variations in film thickness at the time of film formation in inkjet printing can be used to achieve and obtain broadened absorptivity. The variations that are designed to occur include the amount of variation in the manufacturing processes that is controlled. For example, the thickness d2 is designed to have variations in the range from 10 micrometers (μm) to 15 μm. By so doing, an absorber that has absorptivity for about 24 to 32 GHz can be achieved and obtained. In addition to the thicknesses d2 of the dielectric layer 13 arranged between the pair of unit patterns of the upper layer and the lower layer, the sizes of the unit patterns, the areas of the capacitively-coupled portions, the thicknesses of the base material 11, and the thicknesses of the conductive layers may be varied to achieve and obtain broadened absorption.

If the upper and lower portions of the metallic pattern in a direction perpendicular to the plane are not taken into consideration, the size of unit cells in repeated patterns in a direction horizontal to the plane becomes 0.9 mm obtained by an equation “L-G” and becomes 1/19 at the minimum for the wavelength at the peak of absorption. The thickness becomes about 112 μm, and becomes 1/150 at the minimum for the wavelength at the peak of frequency. Accordingly, reduction in thickness can be achieved.

Although the electromagnetic-wave absorber and reflector according to some embodiments of the present disclosure have been described as above in relation to a specific configuration or structure, the configuration or structure of the electromagnetic-wave absorber and reflector is not limited to the above-described embodiments. The features of each configuration may be combined with each other as long as there is integrity or logical coherence. For example, the calculation results described with reference to FIG. 16 and FIG. 17 using the evaluation models described with reference to FIG. 15A and FIG. 15B applies to any of one of the configurations according to the first to third embodiments of the present disclosure. At least one of the thickness of the dielectric layer 13, the size of the multiple unit patterns 15, the area of the capacitively-coupled portion, and the thickness of the base material 11 is designed to have a variation, such that broad absorption characteristics can be realized.

The second capacitively-coupled portion 52b in the horizontal direction that makes use of the gap 552 of FIG. 13 may be combined with electromagnetic-wave absorber and reflector 20, 30, or 40. In such cases, an insulating layer 131 may be arranged in the gap 552 as illustrated in FIG. 14 depending on the accuracy in printing in order to prevent the gap 552 from being conductive. In the cross-sectional shape of the capacitively-coupled portion of the electromagnetic-wave absorber and reflectors 20, 30, 40, and 50 in the stacking direction, any one of the configuration or structure described with reference to FIG. 4 and FIG. 5 may be adopted. Alternatively, in the cross-sectional shape of the capacitively-coupled portion of the electromagnetic-wave absorber and reflectors 20, 30, 40, and 50 in the stacking direction, the ground layer 16 may be arranged on the rear side of the base material 11 as described above with reference to FIG. 6. The shape of the multiple unit patterns 25, 35, 45, and 55 of the electromagnetic-wave absorber and reflectors 20, 30, 40, and 50 is not limited to a rectangle, and may be a circle such as a perfect circle and an ellipse or a polygon such as a triangle, a hexagon, or a cross other than a rectangle. When it is assumed that the shape of the multiple unit patterns 25, 35, 45, and 55 is hexagonal, the multiple unit patterns 15, 25, 35, 45, and 55 may be arranged at even intervals in a honeycomb shape.

When the electromagnetic-wave absorber and reflector according to the present embodiment is applied to a planar or curved array antenna, each unit pattern is provided with a feeding point. The feeding point is arranged at a position where impedance matching is achieved with the corresponding one of the multiple unit patterns. Typically, the oscillation frequency or the resonance frequency of a two-dimensional array antenna is determined by the one-side length or size of the conductor pattern and the intervals of the patterns, and the conductor pattern tends to be upsized at low frequencies equal to or lower than several GHz. By contrast, if the capacity coupling according to the embodiments of the present disclosure is used, the radiation or reception of radio or radar signals of frequencies equal to or lower than several GHz can be handled without increasing the size of the conductor pattern.

In the manufacturing process of the electromagnetic-wave absorber and reflector, at least some of the unit pattern of the conductor is formed by a printing method. The multiple arms that make up the capacitively-coupled portions may be formed by an ink jet method using conductive ink as the conductive material. At least some of the dielectric layer 13 may be formed by a printing method. A portion of the dielectric layer 13 that makes up the capacitively-coupled portion may be formed by an ink jet method using an electrically-insulative ink such as a polyimide-based ink.

In any case, the degree of overlapping between an adjacent pair of the multiple unit patterns including the gap 552 where no overlapping is present or the thickness of the dielectric layer is controlled. By so doing, a desired capacity coupling of the thin-film structure can be formed between a pair of the multiple unit patterns. As a result, the target frequency is shifted to a low frequency, and a thin electromagnetic-wave absorber and reflector in which the upsizing of the multiple unit patterns is prevented can be made and achieved.

For example, the electromagnetic-wave absorber and reflector can be applied to a casing or housing of a smartphone that serves as an electromagnetic wave absorbing sheet. An adhesive layer may be arranged on the rear side of the base material facing toward the ground layer, and the electromagnetic-wave absorber and reflector may be pasted onto such a layer inside the housing. As the size of the multiple unit patterns is controlled, the introduction to the inside of an electronic device such as a compact smartphone or mobile phone can be achieved easily.

The embodiments of the present disclosure as described above may be implemented in the following modes.

### First Mode

An electromagnetic-wave absorber and reflector includes a base material, and a plurality of unit patterns made of conductive material disposed at even intervals on a surface of the base material. In the electromagnetic-wave absorber and reflector according to the first mode, a portion of each one of the plurality of unit patterns overlapping with a portion of adjacent one of the plurality of unit patterns in a stacking direction of the base material, having a dielectric layer interposed in between.

### Second Mode

In the electromagnetic-wave absorber and reflector according to the first mode, each one of the plurality of unit patterns has an arm extending toward the adjacent one of the plurality of unit patterns, and the arm overlaps with the arm of the adjacent one of the plurality of unit patterns in stacking direction, having the dielectric layer interposed in between, to form a capacitively-coupled portion.

### Third Mode

In the electromagnetic-wave absorber and reflector according to the second mode, the capacitively-coupled portion includes a first capacitively-coupled portion in which the pair of arms overlap with each other in the stacking direction in a first area, and a second capacitively-coupled portion in which the pair of arms overlap with each other in the stacking direction in a second area different from the first area.

### Fourth Mode

In the electromagnetic-wave absorber and reflector according to the second mode, the capacitively-coupled portion includes a first capacitively-coupled portion in which the pair of arms overlap with each other in the stacking direction, and a second capacitively-coupled portion formed in a gap to separate an adjacent pair of the plurality of unit patterns in a direction horizontal to a plane of the plurality of unit patterns.

### Fifth Mode

In the electromagnetic-wave absorber and reflector according to the fourth mode, the second capacitively-coupled portion has an insulating layer in the gap.

### Sixth Mode

In the electromagnetic-wave absorber and reflector according to the second mode, the arm overlaps with the arm of the adjacent one of the plurality of unit patterns in length direction.

### Seventh Mode

In the electromagnetic-wave absorber and reflector according to the second mode, the arm overlaps with the arm of the adjacent one of the plurality of unit patterns in width direction.

### Eighth Mode

In the electromagnetic-wave absorber and reflector according to the second mode, the arm has a wide portion where a width of the arm is increased, and the arm overlaps with the arm of the adjacent one of the plurality of unit patterns at the wide portion.

### Ninth Mode

In the electromagnetic-wave absorber and reflector according to any one of the second mode to the eighth mode, the capacitively-coupled portion is made of conductive ink.

### Tenth Mode

In the electromagnetic-wave absorber and reflector according to any one of the second mode to the ninth mode, at least one of thickness of the dielectric layer, a size of the plurality of unit patterns, an area of the capacitively-coupled portion, or thickness of the base material has a designed variation.

### Eleventh Mode

An electromagnetic-wave absorber and reflector includes a base material, a plurality of unit patterns of a first group disposed on a surface of the base material, the plurality of unit patterns of the first group being made of a first conductive material, a dielectric layer covering at least a portion of each one of the plurality of unit patterns of the first group, and a plurality of unit patterns of a second group disposed on the dielectric layer, the plurality of unit patterns of the second group being made of a second conductive material, each one of the plurality of unit patterns of the second group not overlapping with adjacent one of the plurality of unit patterns of the first group in a stacking direction, the dielectric layer being interposed between the plurality of unit patterns of the second group and at least the portion of each one of the plurality of unit patterns of the first group.

### Twelfth Mode

An antenna includes the electromagnetic-wave absorber and reflector according to any one of the first mode to the eleventh mode, and a feeding point disposed on one of the plurality of unit patterns.

### Thirteenth Mode

A method of manufacturing an electromagnetic-wave absorber and reflector includes forming a plurality of unit patterns of a first group on a surface of a base material, the plurality of unit patterns of the first group being made of a conductive material, forming a dielectric layer covering at least a portion of each one of the plurality of unit patterns of the first group, and forming a plurality of unit patterns of a second group on the dielectric layer, the plurality of unit patterns of the second group being made of a conductive material, the plurality of unit patterns of the second group overlapping with the portion of each one of the plurality of unit patterns of the first group in a stacking direction, the dielectric layer being interposed between the plurality of unit patterns of the second group and the portion of each one of the plurality of unit patterns of the first group.

### Fourteenth Mode

In the method of manufacturing the electromagnetic-wave absorber and reflector according to the thirteenth mode, at least one of thickness of the dielectric layer, a size of the plurality of unit patterns of the first group, a size of the plurality of unit patterns of the second group, an area in which the portion of each one of the plurality of unit patterns of the first group overlaps with the plurality of unit patterns of the second group in the stacking direction, or thickness of the base material has a variation.

### Fifteenth Mode

A method of manufacturing an electromagnetic-wave absorber and reflector includes forming a plurality of unit patterns of a first group on a surface of a base material, the plurality of unit patterns of the first group being made of a conductive material, forming a dielectric layer covering at least a portion of each one of the plurality of unit patterns of the first group, and forming a plurality of unit patterns of a second group on the dielectric layer, the plurality of unit patterns of the second group being made of a conductive material, the plurality of unit patterns of the second group not overlapping with the portion of each one of the plurality of unit patterns of the first group in a stacking direction, the dielectric layer being interposed between the plurality of unit patterns of the second group and the portion of each one of the plurality of unit patterns of the first group.

Numerous additional modifications and variations are possible in light of the above teachings. It is therefore to be understood that within the scope of the appended claims, the embodiments of the present disclosure may be practiced otherwise than as specifically described herein. For example, elements and/or features of different illustrative embodiments may be combined with each other and/or substituted for each other within the scope of this disclosure and appended claims. For example, some of the elements described in the above embodiments may be removed. Further, elements according to varying embodiments or modifications may be combined as appropriate.

Any one of the above-described operations may be performed in various other ways, for example, in an order different from the one described above. Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

This patent application is based on and claims priority to Japanese Patent Application Nos. 2022-044204 and 2022-197447, filed on Mar. 18, 2022, and Dec. 9, 2022, respectively, in the Japan Patent Office, the entire disclosure of each of which is hereby incorporated by reference herein.

### REFERENCE SIGNS LIST

10, 10A to 10E, 20, 30, 40, 50 Electromagnetic-wave absorber and reflector
11, 21, 31, 41, 51 Base material
12, 22, 32, 42a, 42b, 42c, 52a, 52b Capacitively-coupled portion
13 Dielectric layer
131 Insulating layer
15, 15-1, 15-2, 25, 35, 45, 55 Unit pattern
151, 251, 351, 451, 452, 551 Arm
552 Gap

1. An electromagnetic-wave absorber and reflector comprising:
a base material; and
a plurality of patterns made of conductive material disposed at even intervals on a surface of the base material,
a portion of each one of the plurality of patterns overlapping with a portion of an adjacent one of the plurality of patterns in a stacking direction of the base material, the portion of each one of the plurality of patterns and the portion of the adjacent one of the plurality of patterns having a dielectric layer interposed in between.

2. The electromagnetic-wave absorber and reflector according to claim 1, wherein;
each one of the plurality of patterns has an arm extending toward the adjacent one of the plurality of patterns, and
one of the arms overlaps with the arm of the adjacent one of the plurality of patterns in the stacking direction, having the dielectric layer interposed in between, to form a capacitively-coupled portion.

3. The electromagnetic-wave absorber and reflector according to claim 2, wherein the capacitively-coupled portion includes:
a first capacitively-coupled portion in which the arm overlaps with the arm of the adjacent one of the plurality of patterns in the stacking direction in a first area; and
a second capacitively-coupled portion in which the arm overlaps with the arm of the adjacent one of the plurality of patterns in the stacking direction in a second area different from the first area.

4. The electromagnetic-wave absorber and reflector according to claim 2, wherein the capacitively-coupled portion includes:
a first capacitively-coupled portion in which the arm overlaps with the arm of the adjacent one of the plurality of patterns in the stacking direction; and
a second capacitively-coupled portion formed in a gap to separate an adjacent pair of the plurality of patterns in a direction horizontal to a plane of the plurality of patterns.

5. The electromagnetic-wave absorber and reflector according to claim 4, wherein:
the second capacitively-coupled portion includes an insulating layer in the gap.

6. The electromagnetic-wave absorber and reflector according to claim 2, wherein;
the arm overlaps with the arm of the adjacent one of the plurality of patterns in a length direction of the arm.

7. The electromagnetic-wave absorber and reflector according to claim 2, wherein:
the arm overlaps with the arm of the adjacent one of the plurality of patterns in a width direction of the arm.

8. The electromagnetic-wave absorber and reflector according to claim 2, wherein:
the arm has a wide portion where a width of the arm is increased, and
the arm overlaps with the arm of the adjacent one of the plurality of patterns at the wide portion.

9. The electromagnetic-wave absorber and reflector according to claim 2, wherein:
the capacitively-coupled portion includes conductive ink.

10. The electromagnetic-wave absorber and reflector according to claim 2, wherein;
at least one of thickness of the dielectric layer, a size of the plurality of patterns, an area of the capacitively-coupled portion, or thickness of the base material has a variation.

11. An electromagnetic-wave absorber and reflector comprising:
a base material;
a plurality of patterns of a first group disposed on a surface of the base material, the plurality of patterns of the first group including a first conductive material;
a dielectric layer covering at least a portion of each one of the plurality of patterns of the first group; and
a plurality of patterns of a second group disposed on the dielectric layer, the plurality of patterns of the second group including a second conductive material, each one of the plurality of patterns of the second group not overlapping with an adjacent one of the plurality of patterns of the first group in a stacking direction, the dielectric layer being interposed between the plurality of patterns of the second group and at least the portion of each one of the plurality of patterns of the first group.

12. An antenna comprising:
the electromagnetic-wave absorber and reflector according to claim 1; and
a feeding point disposed on each one of the plurality of patterns.

13. A method of manufacturing an electromagnetic-wave absorber and reflector, the method comprising:
forming a plurality of patterns of a first group on a surface of a base material, the plurality of patterns of the first group including a conductive material;
forming a dielectric layer covering at least a portion of each one of the plurality of patterns of the first group; and
forming a plurality of patterns of a second group on the dielectric layer,
the plurality of patterns of the second group including a conductive material,
the plurality of patterns of the second group overlapping with the portion of each one of the plurality of patterns of the first group in a stacking direction, the dielectric layer being interposed between the plurality of patterns of the second group and the portion of each one of the plurality of patterns of the first group.

14. The method according to claim 13, wherein;
at least one of thickness of the dielectric layer, a size of the plurality of patterns of the first group, a size of the plurality of patterns of the second group, an area in which the portion of each one of the plurality of patterns of the first group overlaps with the plurality of patterns of the second group in the stacking direction, or thickness of the base material has a variation.

15. (canceled)
